(19) United States
(12) Patent Application Publication
(10) Pub. No.: US 2025/0368000 A1
(43) Pub. Date: Dec. 4, 2025

(54) VEHICLE INTERIOR OBJECT DETECTION AND TEMPERATURE CONTROL

(71) Applicant: FCA US LLC, Auburn Hills, MI (US)

(72) Inventor: Chia-Sung Liu, Novi, MI (US)

(21) Appl. No.: 18/676,900

(22) Filed: May 29, 2024

(51) Int. Cl. B60H 1/00

(52) U.S. Cl. CPC B60H 1/00742; B60H 1/00878

(57) ABSTRACT

A system for controlling temperature within a vehicle includes a temperature sensor, an object detection sensor adapted to detect objects within the vehicle interior and having a laser and a receiver at which is received laser light that is reflected back to the sensor, a temperature control system adapted to alter the temperature within the vehicle interior, and a control system. The control system is coupled to the temperature sensor and to the object detection sensor and to the temperature control system, and is operable to determine a temperature from the temperature sensor and to determine if an object above a threshold size is present within the vehicle interior and to actuate the temperature control system when the temperature meets a temperature threshold and an object above a threshold size is determined to be present within the vehicle interior.

### FIELD

The present disclosure relates to systems for detecting objects within a vehicle interior and for controlling temperature within the vehicle interior.

### BACKGROUND

When vehicles are not in use, they can be exposed to sunlight and high ambient temperatures. The temperature within the vehicle can increase to levels dangerous to people or animals, and damaging to things like certain foods. People sometimes inadvertently leave objects within a vehicle, including objects to which high temperatures can be harmful. Improvements in detecting objects are needed, including objects that do not move or are not emitting sounds or vibrations.

### SUMMARY

In at least some implementations, a system for controlling temperature within a vehicle includes a temperature sensor adapted to provide an indication of a temperature within a vehicle interior, an object detection sensor adapted to detect objects within the vehicle interior, the object detection sensor having a laser from which laser light is emitted and a receiver at which is received laser light that is reflected back to the object detection sensor, a temperature control system adapted to alter the temperature within the vehicle interior, and a control system. The control system is coupled to the temperature sensor and to the object detection sensor and to the temperature control system. The control system includes a processor and memory communicated with the processor and including one or more programs or instructions that are operable to determine a temperature from the temperature sensor and to determine if an object is present within the vehicle interior and to actuate the temperature control system when the temperature meets a temperature threshold and an object is determined to be present within the vehicle interior.

In at least some implementations, the programs or instructions are arranged so that the control system can determine the presence of perishable objects within the vehicle interior.

In at least some implementations, the programs or instructions are arranged so that the control system can determine the presence of a person or animal within the vehicle interior.

In at least some implementations, the object detection sensor is a LIDAR sensor.

In at least some implementations, the temperature control system includes one or more windows that define part of the vehicle interior and that are movable between a closed position and an open position, and wherein the control system is operable to selectively move the windows.

In at least some implementations, an ambient temperature indicator provides to the control system an indication of an ambient temperature outside of the vehicle interior. In at least some implementations, the ambient temperature indicator is a remote source of weather information.

In at least some implementations, a communications device is coupled with the control system and wherein the control system is operable to cause the communications device to selectively transmit a notification in response to at least a temperature that meets a threshold.

In at least some implementations, the object detection sensor provides an indication of a volume of objects within the vehicle interior. In at least some implementations, the control system is operable to compare the volume of objects within the vehicle interior at a first time and at a second time, wherein the second time is a predefined time after a power system of the vehicle is turned off.

In at least some implementations, a load sensor is communicated with the control system and operable to provide an output indicative of a vehicle weight: a) during operation of the vehicle or after powering off the vehicle; and b) after at least one occupant has exited the vehicle after the vehicle has been powered off. In at least some implementations, the load sensor is associated with at least one suspension component of a vehicle.

In at least some implementations, a method of controlling temperature within a vehicle includes determining a temperature within a vehicle interior, determining with a sensor including a laser if an object is present within the vehicle interior, and actuating a temperature control system when the temperature meets a temperature threshold and an object is determined to be present within the vehicle interior.

In at least some implementations, the method includes determining a presence of at least one object within the vehicle interior: a) during operation of the vehicle or after powering off the vehicle; and b) after at least one occupant has exited the vehicle after the vehicle has been powered off.

In at least some implementations, determining the presence of at least one object is accomplished by determining a volume of objects within the vehicle interior.

In at least some implementations, the method includes determining if an object in the vehicle interior is either: a) a person or an animal; or b) a perishable item. In at least some implementations, determining if the perishable item is within the vehicle interior is accomplished by comparison of a detected object shape with predetermined data relating to the shape of one or more containers including perishable items.

In at least some implementations, the method includes determining a weight of the vehicle: a) during operation of the vehicle or after powering off the vehicle; and b) after at least one occupant has exited the vehicle after the vehicle has been powered off. In at least some implementations, the vehicle weight is determined at least in part based upon information from a vehicle ride height system.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a side diagrammatic view of a vehicle having a control system, one or more object detection sensors and a temperature control system;

FIG. 2 is a perspective view of part of a passenger compartment of the vehicle;

FIG. 3 is a diagrammatic view of the vehicle control system; and

FIG. 4 is a flowchart for a method of controlling a temperature in the passenger compartment.

### DETAILED DESCRIPTION

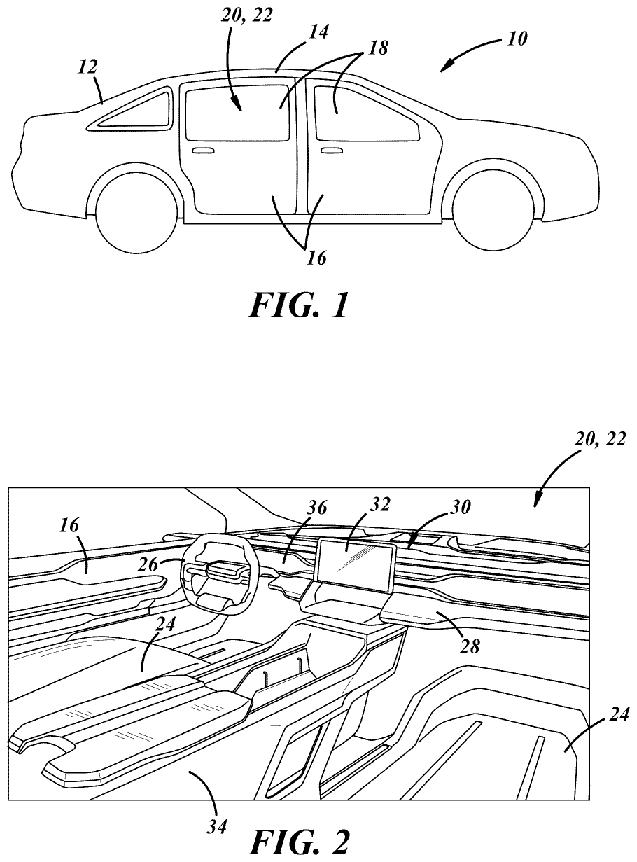

Referring in more detail to the drawings, FIG. 1 illustrates a vehicle 10 that may be of any desired type, such as a car or truck of any type, and may include any desired powertrain like an internal combustion engine, one or more electric motors or a hybrid/combination of different powertrains. The vehicle 10 has a body 12 including various structural members, a roof 14, multiple exterior panels, doors 16 and windows 18. A vehicle interior 20 may include or be defined by a passenger compartment 22 in which occupants of the vehicle 10 are received in use of the vehicle 10. The passenger compartment 22 is defined at least in part by interior surfaces of parts of the vehicle, such as the doors 16, windows 18, interior trim components, the roof 14 and a floor opposite to the roof, and these things may separate the passenger compartment 22 from the exterior of the vehicle 10 and the ambient environment outside the vehicle 10.

FIG. 2 illustrates part of the passenger compartment 22 which may include one or more seats 24, a steering input 26 (e.g. steering wheel), a dashboard 28, infotainment system 30 including a visual display screen 32, a center console 34, and an instrument panel 36, for example. The instrument panel 36 and adjacent areas may include one or more displays for information such as for gauges like a fuel gauge, speedometer, tachometer, and warning lights, an interface for the infotainment system including vehicle settings information or changes, and the like.

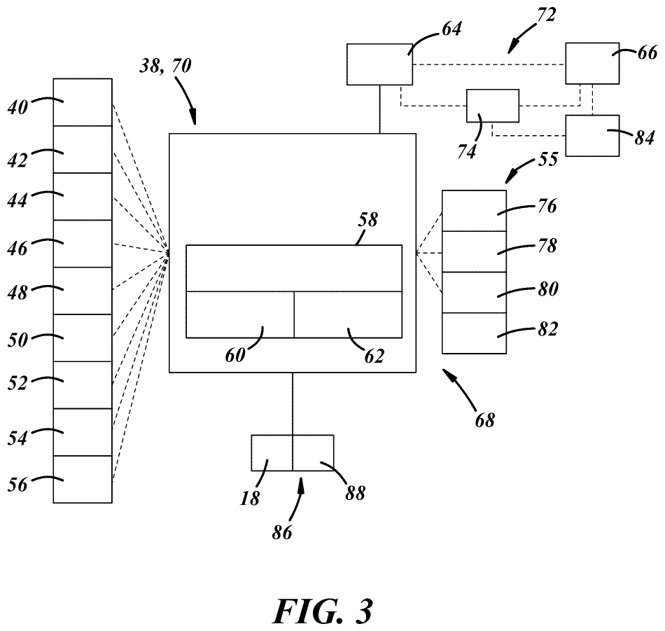

To enable control and monitoring of various vehicle operating, environmental and other conditions related to vehicle operation, a vehicle control system 38 may include or be communicated with a range of sensors, as generally shown in FIG. 3. By way of some examples, the vehicle 10 may include: a speed sensor 40 that provides an indication of vehicle speed; one or more accelerometers 42, such as an inertial measurement unit (IMU) responsive to vehicle accelerations in various directions and orientations; drive input sensors (separate sensors, collectively referred to as 44) that sense the position and/or rate of movement of the throttle, brake and/or steering inputs, door sensors 46, seat occupancy sensors 48, vehicle position or location sensors 50 or devices (such as GPS or the like) to determine the location of the vehicle; interior temperature indicator or sensor 52, exterior or ambient temperature indicator or sensor 54; one or more object detection sensors 55, and a vehicle power on/off switch or sensor 56 by which a prime mover and/or electrical system of the vehicle 10 may be turned on prior to or to start vehicle operation and turned off to end or terminate vehicle operation, and other sensors and indicators.

In order to perform the functions and desired processing set forth herein, as well as the computations therefore, the control system 38 may include, but is not limited to, one or more controller(s), processor(s), computer(s) (generally referred to at 58), DSP(s), memory 60, storage, register(s), timing, interrupt(s), communication interface(s), and input/output signal interfaces, and the like, as well as combinations comprising at least one of the foregoing. For example, the control system 38 may include input signal processing and filtering to enable accurate sampling and conversion or acquisitions of such signals from communications interfaces and sensors. As used herein the terms control system 38 may refer to one or more processing circuits such as an application specific integrated circuit (ASIC), an electronic circuit, a processor (shared, dedicated, or group) and memory that executes one or more software or firmware programs 62, a combinational logic circuit, and/or other suitable components that provide the described functionality. The control system 38 may be distributed among different vehicle modules, such as an infotainment control module, engine control module or unit, powertrain control module, transmission control module, and the like, if desired, and one or more processors 58 and the memory 60 and associated instructions or programs 62 may be one or both integrated into the vehicle 10 or remotely located and wirelessly communicated to the vehicle 10, as desired.

The term “memory” or “storage” as used herein can include computer readable memory, and may be volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory can store an operating system and/or instructions executable by a processor or controller or the like to enable control or allocate resources of a computing device.

The control system 38 may include or be coupled with (by wired or wireless connection) a communications device 64 (e.g., one that includes a telematics unit and/or other communication devices) that may permit two-way communication to and from the vehicle from a remote source or device. The control system 38 may be or include a telematics control module (TCM), and communication may occur from the vehicle 10 directly to a remote device or through an intermediary like a cloud-based backend portion 66 of a communication system that provides an application interface or other hosted services for communication between a user and the vehicle 10.

The systems and methods described herein may utilize hosted services via the internet and/or other communication networks and that may be structured as a public, private or hybrid cloud, for example. According to one non-limiting example, the vehicle temperature alert and temperature control system 68 is structured as a private cloud and generally includes the backend portion 66 and a frontend portion 70 that may be provided within each of multiple, vehicles 10, i.e., a fleet of vehicles 10, where each vehicle 10 is capable of obtaining and providing information as well as communicating with the backend portion 16 over a secure communications network 72 (e.g., secure vehicle-to-cloud (V2C) network). The secure communications network 72 may include a cellular-based network, a satellite-based network, a city-wide WiFi-based network, some other type of communications network and/or a combination thereof.

To facilitate communication with users, application interfaces enabling two-way communication between remote devices 74, like smartphones and computers, and vehicles, are known and may be implemented in any desired manner. Such interfaces permit communication of information such as vehicle status information as well as user-initiated commands. Vehicle status information may include things like tire pressures, fuel level, and oil life remaining. User-initiated commands may include things like remote starting of an engine, locking or unlocking doors, and opening or closing windows.

In at least some implementations, the systems and methods noted herein enable detection of people, animal and other things within a vehicle 10, and at least a temperature within the vehicle 10, including when the vehicle 10 is parked and not in use. One or more object detection sensors 55 and one or more temperature sensors, such as the interior temperature sensor 52 and exterior or ambient temperature sensor 54, may be used for these determinations and such sensors may be communicated with the vehicle control system 38 to permit automated actions such as sending of notifications from the vehicle 10 to a remote device, and in at least some implementations, control of one or more systems that permit adjustment of the temperature within the vehicle interior 20.

In at least some implementations, the vehicle 10 may include a load sensor 76 by which a weight of the vehicle 10 or a portion thereof can be determined, and the load sensor 76 may be used as an object detection sensor 55 as set forth herein. The load sensor 6 may permit determination of a weight of the vehicle 10 with and without occupants and other objects within the vehicle interior 20. From this information, a determination can be made as to whether occupants or objects have been removed from the vehicle interior 20, or if occupants or objects are still within the vehicle 10 at a point in time.

In at least some implementations, the load sensor 54 may be associated with a vehicle ride height system that includes a ride height adjustment device, such as a suspension component having a pressurized fluid (hydraulic or pneumatic) the pressure of which can be changed to alter the vehicle ride height. For example, increased load in or on the vehicle 10 can cause the vehicle suspension to permit vehicle 10 travel toward the ground, reducing ride height (e.g. clearance between the vehicle 10 and the ground). The pressure of the suspension component fluid may be increased to raise the vehicle body relative to the ground, and the pressure required to achieve a desired ride height is a function of the load on the vehicle 10 and can be used by the control system 38 to estimate the vehicle load. Of course, ride height adjustment systems may use actuators other than pressurized fluid components, such as those driven by electric motors or other electromechanical systems. In at least some implementations, a movement or other change in the suspension system can be correlated to a load associated with one or more objects temporarily in the vehicle interior 22. This may be done as a function of one or both of the magnitude of a change in the vehicle ride height and/or a force from the ride height adjustment device needed to increase the ride height.

The vehicle 10 may also include one or more other object detection sensors 55 arranged in the vehicle interior 20 to permit determination of the presence of occupants and objects within the vehicle interior 20. The object detection sensors 55 may be of various types, including but not limited to one or more cameras 78, radar sensors 80, LiDAR sensors 82, seat occupancy sensors 48, and other sensors like vibration sensors, movement sensors, noise sensors and the like. Cameras 78 may provide data for object recognition programs by which the type of objects within a field of view of the cameras can be determined. Radar, LiDAR, ultrasonic and electromagnetic sensors have transmitters that emit, respectively, radio waves, laser light, ultrasonic waves and magnetic fields, and receivers that receive reflections of the emissions that are directed back toward the sensors by surfaces of objects in the path of the emissions. Seat occupancy sensors 48 may be actuated by something on the seat bottom having at least a threshold weight, and may be a simple switch or other device, as desired. In at least some implementations, one or more cameras 78 are provided within the passenger compartment 22 and have a field of view that includes all or a majority of the passenger compartment, such as the seating area of the passenger compartment. In at least some implementations, at least one camera may be mounted to the roof in the passenger compartment and have a field of view that includes at least part of the seat bottom of each seat 24. Further, one or more other object detection sensors 55, like a RADAR or LiDAR sensor may be mounted to the roof in the passenger compartment 22, if desired.

To assist in determining the presence of an object in the vehicle interior 20 (e.g. passenger compartment 22), signals, image information or sensor information relating to things that are within the passenger compartment 22 when it is empty of occupants (e.g. portions of the vehicle 10 like the seats 24, steering wheel 26, consoles, interior surfaces and the like) can be known. This information can be used by the system to determine the presence of occupants or objects in the passenger compartment 22 by comparison with different information that is provided from the object detection sensor(s) when occupants and other things are temporarily in the passenger compartment 22. For example, an object, person or animal on a vehicle seat 24 will reflect emissions back toward a sensor, or provide different image data, or a different signal from a seat occupancy sensor 48, than if the object, person or animal was not in the vehicle seat 24. Further, animate objects may move which can be detected by the object detection sensors which may also include one or more accelerometers such as the IMU, and animate objects may create movement and noise detectable by one or more vibration, movement or noise detection sensors, which may also be considered to be object detection sensors.

In at least some implementations, the system may include information relating to some type of objects commonly found in vehicles. For example, the system may be able to determine the presence of people and animals within the vehicle interior 20, at least in part by reference to background information against which object detection sensor information can be compared. A match or positive determination of the presence of a person or animal in the passenger compartment 22 can be made when the sensor information is within a threshold or thresholds of similarity to background information. Similarly, certain other objects may be determined by comparison of sensor information to known information. In at least some implementations, the system may detect the presence of one or more perishable items within the vehicle 10. This may be done, for example, by determination of the presence of individual perishable items or a collection of them, or the packaging or container of a collection of such items, like a grocery bag, grocery tote or the like.

Further, the system may use information from the object detection sensors 55 to determine a volume of objects within the vehicle 10, which include or not include objects that are part of the vehicle 10, like the seats 24, steering wheel, and the like. In at least some implementations, the volume of one or more objects may be determined when the vehicle 10 is in use, or when the vehicle 10 is powered off (e.g. engine shutdown, electrical system shutdown, off button actuated, or the like, as determined by switch or sensor 56), or otherwise as desired. Then, the system may detect the opening and closing of one or more vehicle doors 16 after the vehicle 10 is powered off, indicating that occupants have left the vehicle 10, and the object detection sensor(s) 55 may be actuated to determine object volume in the passenger compartment 22. The object volume(s) determined at these times may be compared to assist in determining if one or more objects remain in the vehicle 10, after at least some occupants have exited the vehicle 10.

Next, the temperature within the passenger compartment 22 can be determined from one or more temperature sensors 52, 54 providing a signal to the control system 38 that is indicative of the interior temperature. Further, the temperature outside of the vehicle 10 can be determined by a temperature source 84 (FIG. 3) or an exterior temperature sensor 54 of the vehicle 10. The temperature source 84 can be any source of weather information such as data from a weather service that is obtainable by the vehicle control system 38 via the communication device 64, or via a remote device, like a smartphone, coupled to the vehicle 10 by a wired or wireless connection. From whatever source, the control system 38 can have information indicative of the ambient/exterior temperature.

To permit control of the interior temperature of the vehicle 10 (e.g. the temperature in the passenger compartment 22), the vehicle 10 includes one or more temperature control features that are part of or define the temperature control system 68. The temperature control system 68 may include one or both of: 1) one or more movable windows 18 that selectively communicate the ambient environment with the passenger compartment 22; and 2) a heating, ventilation and air conditioning (HVAC) system 88.

The movable windows 18 may be carried by the vehicle doors 16, or otherwise, as desired, and are driven by electric motors between a closed position in which an opening in which a window 18 is received is closed off from the environment outside the vehicle 10 and one or more open positions in which air may flow between the environment and the passenger compartment 22 through the window opening. To control operation of the windows 18, one or more switches may be provided within the passenger compartment 22 for manual actuation by occupants of the vehicle 10. In at least some implementations, the control system 38 may be coupled to the motors to enable operation of the windows 18 without actuation of the switches, if desired. Through the communications device 64, signals to actuate the motors and move the windows may also be received from a remote source, such as from a remote device 74 like a smartphone, tablet or computer using a software application interface to communicate with the vehicle 10, in known manner.

The HVAC system 88 may include one or more blowers or fans that move air into and within the passenger compartment 22. The air may be heated or cooled, or may simply be a forced air flow without actively being heated or cooled (e.g. a vent or fan option). The HVAC system 88 may be controlled by actuation of one or more inputs in the passenger compartment 22, which be mechanical switches, menu options presented on a touch responsive screen of the infotainment system, or otherwise as desired. Remote actuation of the HVAC system 88 can be accomplished via a remote device 74 and software application, and the through the vehicle communication device.

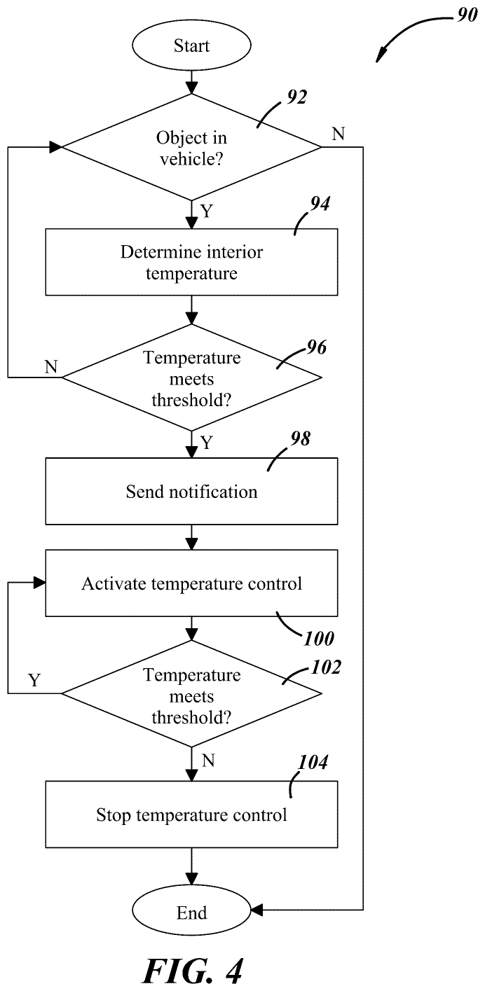

FIG. 4 shows an implementation of a method 90 for determining presence of one or more objects in a vehicle 10, and actuating a temperature control system 68 of the vehicle 10 if the temperature in the passenger compartment 22 meets a threshold. The method may start at step 92 in which it is determined if one or more objects are within the passenger compartment 22 after the vehicle 10 is shutoff. This step may be performed, for example, after the vehicle 10 is shutoff and one or more doors are detected as having been opened and closed, indicating that one or more occupants have exited the vehicle 10. Step 92 may be performed after some time delay, as desired, and additional door openings and closings may reset the time delay, if desired. This ensures, for example, that all occupants who intend to exit the vehicle 10 have time to do so.

Step 92 may involve detection of any object within the vehicle 10 that is not part of the vehicle 10, or it may involve detection of certain objects such as a person, animal or perishable object. Here, perishable object may include items predetermined to be negatively affected by extreme temperatures, which may develop within the interior of a parked vehicle 10. Any of the object detection sensors may be used to determine the presence of an object, such as by weight, size or volume, movement, noise or the like. In at least some implementations, the object size or volume is determined and a size threshold is provided. Objects smaller than the size threshold, which may be set (if desired) to avoid positive determinations for things like sunglasses, phones, wallets, bottles of water or drinking glasses, and the like. The threshold may be set so that a grocery bag, pet (dog, cat or the like) or an infant or toddler is positively determined, but smaller things are not. In at least some implementations, the object size threshold is at least 8 inches in at least two dimensions, and may be at least 12 inches in at least two dimensions. Smaller sized items may also be of interest, for example, a small bottle, bag or other container of medicine, phone, glasses or the like. The size threshold may be adjustable and chosen by a user, if desired, up to the size restrictions/parameters of the object sensor being used. In at least some implementations, the system may include object recognition software to try and determine the type or nature of objects that remain in a vehicle, based on the object detection sensor data.

If no object is detected in step 92, the system may loop back one or more times to confirm this determination before ending, or the method may proceed to the end. If an object is detected in step 92, then the method may proceed to step 94 in which the temperature within the passenger compartment 22 is determined. This may be done by querying the interior temperature sensor. In step 96, the interior temperature is compared to a temperature threshold, and if the threshold is not met, the system may loop back, for example after some time delay, to periodically check the interior temperature against the temperature threshold.

If the interior temperature is determined to meet the temperature threshold in step 96, then the method may proceed to step 98 in which a notification is sent from the vehicle control system 38 via the communication device. The notification may be sent directly to a remote device 74 in the form of, for example, a text message, email, or other electronic message, the notification may be sent to a backend portion of a cloud-based or other remote system. The message my include an indication of the object(s) determined to be within the vehicle 10 and the recipient of the message can then determine an action to take. To facilitate determination of whether an object is within the vehicle 10, the notification may include one or more images from a camera in the passenger compartment 22, and the message recipient can then review the images. The recipient/user can either return to the vehicle 10 or control one or more vehicle features, like the temperature control system 68 to adjust the interior temperature (e.g. the user may remotely (e.g. via an app) activate the HVAC, or open one or more windows). The user action may terminate the method, or the user can separately terminate the method by suitable selection in the app or other interface which may be done, for example, when the user confirms that no object is within the vehicle 10, or any object therein is suitable to remain in the passenger compartment 22 at the noted interior temperature.

The method may continue to step 100 in which some part or feature of the temperature control system 86 is actuated to alter the temperature within the passenger compartment 22. For example, if the interior temperature is above a high temperature threshold, then the HVAC system 88 can be actuated to cool the passenger compartment 22 with a forced air flow or a chilled forced air flow. In addition to or instead, one or more windows may be at least partially opened to permit air flow between the outside environment and the passenger compartment 22. Prior to opening a window, the system may determine the ambient temperature and compare the ambient temperature to an ambient temperature threshold to ensure that opening a window will not negatively affect the interior temperature. That is, if the ambient temperature is too high, opening the window in an attempt to cool the passenger compartment 22 might not be effective, and in that case, the windows may be left closed.

The method may then continue to step 102, which may occur after a time delay, to again check the interior temperature against the temperature threshold. If the interior temperature no longer meets the threshold, one or more of the temperature control features can be deactivated in step 104 (e.g. the HVAC system 88 may be turned off and/or the windows rolled up). If the interior temperature meets the threshold, then the system may loop back to step 100 to ensure the temperature control feature(s) remain activated or are reactivated, and to then recheck the temperature after some time delay. Throughout the method, notifications may be provided from the vehicle 10 to a user or user interface, to alert the user of the actions taken, and the interior temperature, and other information, as desired.

In at least some implementations, the systems and methods utilize a laser-based sensor to determine presence of objects within the passenger compartment 22, and/or a load sensor that determines weight of the vehicle 10 or part thereof. The laser-based sensor, like a LIDAR sensor may be positioned within or be otherwise operable within the passenger compartment 22 to permit the laser light to be emitted within the passenger compartment 22. The shape and volume of objects within the passenger compartment 22 can be determined by the sensor(s).

The systems and methods may be useful to, at least when one or more objects are detected within a vehicle 10, moderate the temperature within the passenger compartment 22 to ensure the interior temperature does not become too high, as may occur when a parked vehicle 10 is acted on by sunlight and/or in an area with higher ambient temperatures. The systems and methods could also be used to provide heat into the passenger compartment 22 when the interior temperature is lower than a cold temperature threshold, which can occur when the ambient temperature is low. In such instances, opening the windows is not effective, but the HVAC system 88 can be activated to provided a heated, forced air flow into the passenger compartment 22.

The methods disclosed herein may include steps that may be carried out in a different order and by systems integrated into the vehicle 10, remote devices 74 that communicate with the vehicle 10, or both. Further, more or fewer method steps may be used in different implementations of the method, as desired. The methods and systems of the disclosure can relate to any type of vehicle 10, and the vehicles may be used for any purpose.

What is claimed is:

1. A system for controlling temperature within a vehicle, comprising:
a temperature sensor adapted to provide an indication of a temperature within a vehicle interior;
an object detection sensor adapted to detect objects within the vehicle interior, the object detection sensor having a laser from which laser light is emitted and a receiver at which is received laser light that is reflected back to the object detection sensor;
a temperature control system adapted to alter the temperature within the vehicle interior; and
a control system coupled to the temperature sensor and to the object detection sensor and to the temperature control system, the control system includes a processor and memory communicated with the processor and including one or more programs or instructions that are operable to determine a temperature from the temperature sensor and to determine if an object is present within the vehicle interior and to actuate the temperature control system when the temperature meets a temperature threshold and an object is determined to be present within the vehicle interior.

2. The system of claim 1 wherein the programs or instructions are arranged so that the control system can determine the presence of perishable objects within the vehicle interior.

3. The system of claim 1 wherein the programs or instructions are arranged so that the control system can determine the presence of a person or animal within the vehicle interior.

4. The system of claim 1 wherein the object detection sensor is a LiDAR sensor.

5. The system of claim 1 wherein the temperature control system includes one or more windows that define part of the vehicle interior and that are movable between a closed position and an open position, and wherein the control system is operable to selectively move the windows.

6. The system of claim 5 which also includes an ambient temperature indicator that provides to the control system an indication of an ambient temperature outside of the vehicle interior.

7. The system of claim 6 wherein the ambient temperature indicator is a remote source of weather information.

8. The system of claim 1 which includes a communications device coupled with the control system and wherein the control system is operable to cause the communications device to selectively transmit a notification in response to at least a temperature that meets a threshold.

9. The system of claim 1 wherein the object detection sensor provides an indication of a volume of objects within the vehicle interior.

10. The system of claim 9 wherein the control system is operable to compare the volume of objects within the vehicle interior at a first time and at a second time, wherein the second time is a predefined time after a power system of the vehicle is turned off.

11. The system of claim 1 which also includes a load sensor communicated with the control system and operable to provide an output indicative of a vehicle weight: a) during operation of the vehicle or after powering off the vehicle; and b) after at least one occupant has exited the vehicle after the vehicle has been powered off.

12. The system of claim 11 wherein the load sensor is associated with at least one suspension component of a vehicle.

13. A method of controlling temperature within a vehicle, comprising:
determining a temperature within a vehicle interior;
determining with a sensor including a laser if an object is present within the vehicle interior; and
actuating a temperature control system when the temperature meets a temperature threshold and an object is determined to be present within the vehicle interior.

14. The method of claim 13 which includes determining a presence of at least one object within the vehicle interior: a) during operation of the vehicle or after powering off the vehicle; and b) after at least one occupant has exited the vehicle after the vehicle has been powered off.

15. The method of claim 14 wherein determining the presence of at least one object is accomplished by determining a volume of objects within the vehicle interior.

16. The method of claim 13 which includes determining if an object in the vehicle interior is either: a) a person or an animal; or b) a perishable item.

17. The method of claim 16 wherein determining if the perishable item is within the vehicle interior is accomplished by comparison of a detected object shape with predetermined data relating to the shape of one or more containers including grocery items.

18. The method of claim 11 which includes determining a weight of the vehicle: a) during operation of the vehicle or after powering off the vehicle; and b) after at least one occupant has exited the vehicle after the vehicle has been powered off.

19. The method of claim 18 wherein the vehicle weight is determined at least in part based upon information from a vehicle ride height system.
